(19) United States
(12) Patent Application Publication
(10) Pub. No.: US 2024/0117496 A1
(43) Pub. Date: Apr. 11, 2024

(54) YTTRIA-COATED REFRACTORY METAL COMPONENT

(71) Applicant: PLANSEE SE, Reutte (AT)

(72) Inventors: Robert Schiftner, Reutte (AT); Katrin Knittl, Reutte (AT); Thomas Huber, Reutte (AT); Michael Mark, Reutte (AT)

(21) Appl. No.: 18/257,646

(22) PCT Filed: Nov. 25, 2021
(86) PCT No.: PCT/AT2021/060447

§ 371 Date: Jun. 15, 2023

(30) Foreign Application Priority Data
Dec. 15, 2020 (AT) GM50251/2020

(51) Int. Cl. C23C 24/00

(52) U.S. Cl. CPC C23C 24/00

(57) ABSTRACT

A component formed of a refractory metal has a surface that is at least partially coated with a layer of yttria. There is also described a method of manufacturing a coated component, and the application of Y₂O₃ as a release agent in high temperature applications.

The present invention relates to a component comprising a refractory metal, characterized in that the surface of the component is at least partially coated with a layer of Y₂O₃.

The invention further relates to the manufacture of the coated component and the use of Y₂O₃ as a release agent in high temperature applications.

In high-temperature plants, such as sintering furnaces, heat treatment plants and a quartz melting plants, or also in lighting plants and evaporation plants, there is the use of components which must be detachable even after repeated exposure to temperature and stress. The detachability of such components after exposure to high temperatures in the range of 1000° C. to 1400° C. presents a particular challenge, since the typically metal-fabricated components tend to sinter on their contact surface with the mating contact surface, the phenomenon of seizing. If the contact surfaces are additionally subjected to pressure, as in the case of a screw connection, for example, the metallurgical bonding of the contact surface pairs is further promoted. Thereafter, the contact surface pairs can no longer be separated from each other without causing damage and the separation causes the destruction of at least one component.

To avoid this problem, various material combinations or auxiliaries and separating agents, such as sleeves or applied separating layers of pastes, are used. However, these methods quickly reach their limits under extreme conditions. For example, some auxiliaries and release agents cannot be used in a vacuum due to the risk of evaporation of their components and/or their operating temperature is limited due to decomposition. Currently, Al₂O₃, ZrO₂ or boron nitride sprays or powders are used for application in furnace construction. However, these variants are unsuitable for applications with temperatures around 1400° C., since in particular cross-contamination between components and the auxiliary and release agent is a problem.

In the production of coarse-grained, creep-resistant molybdenum charging sheets, recrystallization annealing at temperatures of 1700° C. to 1900° C. is necessary, whereby sheets partially sinter in the stack and are therefore no longer separable after the annealing run. Until now, tungsten thin sheet has been used as a separation aid. However, the disadvantage is that the tungsten thin sheets can only be used once and thus contribute significantly to the high manufacturing costs of charging sheets.

DE 102013213503 relates to a threaded connection for vacuum applications comprising a screw with external threads and a component with internal nut threads, wherein either the component or the screw or both are formed from a stainless austenitic steel, wherein different pairs of contact surfaces are created by coating the component/screw with coating materials different from the base materials, allowing mutual sliding without lubricants harmful to vacuum.

In GB201110939, there is provided a first member suitable for selectively engaging a second member, the first member comprising a coating and at least an engaging portion of the first member being coated in the coating, the coating being formed by vapor deposition to provide a thermochemically stable layer for temperatures up to 800° C. The coating may comprise one or more nitrides, oxides, or carbides of titanium, chromium, or aluminum. For example, the coating may comprise one or more titanium nitride, chromium nitride, aluminum nitride, titanium oxide, chromium oxide, aluminum oxide, titanium carbide, chromium carbide, or aluminum carbide.

In the field of high-temperature treatments, the use of particularly high temperatures of 1400° C. to 1900° C. is increasingly required. At the same time, increasingly stringent requirements are laid down on the purity of the treated products.

Accordingly, the object of the present invention is to provide a coated component which is detachable even after use at temperatures in the range from 1000° C. to 1400° C., in particular up to 1900° C., wherein no cross-contamination with other components or treated products occurs.

This object is solved by providing a component according to claim 1 consisting of a refractory metal, the surface of which is at least partially coated with a layer of Y₂O₃, its production as well as the use of Y₂O₃ as a separator agent in high temperature applications. Advantageous embodiments of the invention are the subject of the dependent claims, which can be freely combined with each other.

The use of a layer of Y₂O₃ allows the components to be used in different atmospheres, such as hydrogen or in a vacuum, without the risk of cross-contamination or a decomposition. The application of these layers also ensures the non-destructive replacement and non-destructive opening of components, respectively. Sintering of component parts can thus be prevented and it can hence be ensured that they remain detachable. With the Y₂O₃ layer in particular a temperature application range of 1000° C. to 1400° C., in particular up to 1900° C. can be covered without risk of pollution/contamination or seizing, and the detachability of the components/machine elements can be achieved.

According to the present invention, a connection is detachable if surfaces of components that are in direct contact with each other can be separated from each other again without damaging the components, and it is not detachable if the components have to be at least partially destroyed in order to separate the contacting surfaces from each other again.

The coated component according to the invention is particularly suitable for high-temperature applications, i.e. for applications with temperatures in the range from 1000° C. to 2000° C., presently in particular 1400° C. to 1900° C.

To withstand these temperatures, the component of the present invention consists of a refractory metal.

In the context of the present invention, a refractory metal is understood to be a metal selected from the group consisting of titanium, zirconium, hafnium, vanadium, niobium, tantalum, chromium, molybdenum, tungsten and rhenium and alloys of said metals, also referred to herein as refractory metal alloys. Refractory metal alloys are alloys with at least 50 at. % of one or more of the above-mentioned metals, preferably with at least 70 at. %, further preferred with at least 90 at. % and even more preferably with at least 95 at. %.

It is understood that the melting point of the refractory metal defined above is selected so that the component is suitable for the temperature targeted in use. Preferably, the refractory metal has a melting point greater than 1400° C., more preferably greater than 1800° C., and more preferably greater than 2000° C.

In one embodiment, the component comprises molybdenum, besides unavoidable impurities, or a molybdenum alloy.

In one embodiment, it is further preferred that the alloy comprises, in addition to molybdenum, up to 30% by weight of further of the above-mentioned refractory metal elements.

In a further embodiment, it is preferred that compositions consist, in addition to molybdenum, of the following percentages of elements by weight:

0.5 wt % Ti and 0.08 wt % Zr and 0.01 wt % to 0.04 wt % C. 1.2 wt % Hf and 0.01 wt % to 0.04 wt % C. 0.3 wt % La₂O₃. 0.7 wt. % La₂O₃. 0.47 wt. % Y₂O₃ and 0.08 Ce₂O₃. 0.005 to 0.1 wt. % K and 0.005 wt. % to 0.1 wt. % Si and 0.01 to 0.2 wt. % 0.5 wt. % Re or 41 wt. % Re. 30 wt. % W. Furthermore, compositions are also included in which the proportions given here differ by up to 10%.

The proportions given and the data refer to the element referred to in each case (e.g., Mo, C or W), irrespective of whether it is present in the molybdenum base material in elemental or bound form. The proportions of the various elements are determined by chemical analysis.

The term component in the sense of the present invention includes individual parts (machine elements, components), in particular construction means which are suitable for the exchange or reversible fastening and loosening of machine elements, as well as assemblies composed of individual parts. Suitable components are in particular screws, nuts, pins, locating pins, washers, bolts, sheets, clips, tubes, rods and U-rails. As assemblies, mention may be made in particular of welded and riveted components, such as gas inlet tubes, heater suspensions and charging racks. The term components as a used in the present invention specifically excludes cutting parts of cutting tools.

Preferred components as production aids are contact parts, such as separator sheets and washers. In particular, separator sheets are preferred.

In addition, preferred components as production aids are components that have a thread, such as a screw or a nut. A screw is particularly preferred.

According to the invention, the coating of the component consists of Y₂O₃. The Y₂O₃ coating is typically applied to the component by brushing, spraying, printing or dipping of a Y₂O₃ suspension and subsequently drying. Preferably, the Y₂O₃ suspension is an ethanol-based suspension.

Preferably, the Y₂O₃ suspension is sintered onto the component in a hydrogen atmosphere at about 1800° C. for a period of 2 to 6 h. This improves the initial layer adhesion.

The coated components have a Y₂O₃ layer with a thickness in a range from 10 μm to 150 μm, preferably 20 μm to 110 μm, more preferably 40 μm to 80 μm and further preferably 50 μm to 70 μm. The thickness of the layer can be determined by lateral SEM measurement of a transverse section of the coated component. The component typically does not have any other layers of other materials. If other layers are present, for example to provide adhesion, the Y₂O₃ layer is the outermost layer of the coated component.

Typically, the layer is completely applied to the coated component's surface which is to be contacted with further components. In order to achieve improved detachability of the components, it is already sufficient if the layer is only partially applied to the coated component's surface which is to be contacted with further components.

Preferably, 20 to 100% of the coated component's surface which is to be contacted with a further component is coated with the layer, further preferably 50 to 100%.

The present invention can be used wherever good releasability of a component from a another component is required after the component has been used in high temperature applications. Accordingly, the use of Y₂O₃ as a release agent to improve the releasability of components for high temperature applications is also subject-matter of the present invention. Preferably, the yttria is used in the form of a layer applied by means of slurry coating, preferably on a component consisting of a refractory metal.

Further advantages of the invention will be apparent from the following description of examples of embodiments.

### EXAMPLE 1: SCREW CONNECTION

TZM plate (molybdenum with a weight fraction of 0.5 Ti and 0.08 Zr as well as 0.01 to 0.04 C) 140×80×9 mm, 9 mm deep through bore milled with M6 thread

Molybdenum washer: 18×6, 4×1.5 mm

Molybdenum screw: M6×12 mm

Several screws were coated by slurry coating with a Y₂O₃— (according to the invention), ZrO₂—, TaC— or ZrC— suspension and then dried. The coatings had a thickness in the range of 50 to 70 μm.

As indicated in the table below, several tests were conducted to evaluate the Y₂O₃ coating versus the comparative coatings under different conditions. For this purpose, three screws (S1 to S3) with washers were selected in each case and screwed into the plate at a tightening torque of 12 Nm. High temperature treatments were performed at temperatures (T (in ° C.)) ranging from 400° C. to 1400° C. and different atmospheres (A) (hydrogen (H), vacuum 10⁻⁶ mbar (V)) with a holding time of 2 h. The opening torque (L (in Nm)) was measured after the high temperature treatment and the threads were visually inspected for seizing (S) and, if applicable, breakage (B) of the screw was detected.

| | | | S1 | | | S2 | | | S3 | | | Total | | |
|---|---|---|---|---|---|---|---|---|---|---|---|---|---|---|
| Layer | T | A | L | S | B | L | S | B | L | S | B | L | S | B |
| Y₂O₃ | 400 | V | 0 | no | no | 0 | no | no | 0 | no | no | lower | no | no |
| Slurry | 1000 | V | 5 | no | no | 5 | no | no | 5 | no | no | lower | no | no |
| | 1400 | V | 5 | no | no | 5 | no | no | 10 | yes | yes | lower | partly | partly |
| | 1400 | H | <5 | no | no | <5 | no | no | <5 | no | no | lower | no | no |
| ZrO₂ | 400 | V | 15 | yes | no | 15 | yes | no | 15 | yes | no | similar | yes | no |
| Slurry | 1000 | V | 10 | yes | no | 10 | yes | no | 10 | yes | no | similar | yes | no |
| | 1400 | V | 12 | yes | no | 10 | yes | no | 10 | yes | no | similar | yes | no |
| | 1400 | H | 10 | yes | no | 10 | yes | no | 10 | yes | no | similar | yes | no |
| TaC | 400 | V | 15 | yes | no | 15 | yes | no | 15 | yes | no | similar | yes | no |
| Slurry | 1000 | V | 10 | yes | no | 10 | yes | no | 10 | yes | no | similar | yes | no |
| | 1400 | H | 10 | yes | no | 10 | yes | no | 10 | yes | no | similar | yes | no |
| ZrC | 400 | V | 10 | no | no | 10 | no | no | 10 | no | no | similar | no | no |
| Slurry | 1000 | V | 5 | yes | no | 5 | yes | no | 5 | yes | no | lower | yes | no |
| | 1400 | H | 10 | yes | no | 10 | yes | no | 10 | yes | no | similar | yes | no |

As can be seen from the above table, the ZrO₂ and TaC coated screws already show seizing at low temperatures as of 400° C. and are therefore unsuitable for high-temperature applications. The ZrC-coated screws show seizing above 1000° C. and are therefore also unsuitable for high-temperature applications.

In contrast, with the Y₂O₃ coating according to the invention, no seizing of the screw connection occurs. Consequently, the coating can achieve the detachability of contacting refractory metal components. In addition, no cross-contamination between the components could be detected.

### EXAMPLE 2: PRODUCTION AND EVALUATION OF COATED RELEASE SHEETS

Various products were tested and evaluated as possible release agents for stack annealing of sheets. For this purpose, the different release agents were applied between the sheets. The sprays or suspensions were applied on one side of 1 mm thick molybdenum sheets (area about 40×20 mm). The applied layers had a thickness between 50 and 70 μm. 25 sheets were annealed in a stack at 1900° C. for one hour in a hydrogen atmosphere.

The evaluation results are summarized below:

ZrO₂ slurry via corrosion lab (ISTO) as pump spray: separation only possible with tools; slurry “baked” onto sheets; unsuitable.

Al₂O₃ solid via corrosion lab (ISTO), ceramics, 99.7% purity: separation only possible with tool; ceramics partly with edge marks from sheets; unsuitable.

### Boron Nitride Spray (Spray Henze HeBoCoat 21E):

Sheets separable after annealing, but a 10-20 μm thick molybdenum boride layer forms during annealing; unsuitable.

ZrO₂ Spray (Spray from ZYP Coatings Inc. 98% ZrO₂, 0.7% MgO, 1.2% SiO₂):

The sheets are separable after annealing, but the spray layer is mainly loose on the sheet. Contamination of the plant due to flaking of the ZrO₂ spray layer; unsuitable.

ZrO₂ Solid 80 μm Ceramic from CeramTec 3YSZ:

The solid sticks to the sheet and the sheets can only be separated with resistance; the solid is very difficult to remove and in some cases cannot be removed completely; unsuitable.

ZrO₂ Solid 300 μm Ceramic from CeramTec 5YSZ:

The solid sticks to the sheet and the sheets can only be separated with resistance. The solid is very difficult to remove and in some cases cannot be removed completely, and a an imprint of the solid appears on the opposite side; unsuitable.

ZrO₂ Suspension from Sindlhauser Materials Type Zr-W-37:

The suspension shows poor wetting of the sheets in the brush application process. After annealing, the sheets are strongly stuck together in the sandwich and the coating cannot be removed from the coated sheets. In some cases, residues of the coating are found on uncoated sheet sides; unsuitable.

Y₂O₃ Suspension from Sindlhauser Materials Type Y-E-32:

The suspension shows good wetting of the sheets in the brush application process. The sheets can be separated well after annealing. There are no residues of the coating on the uncoated sheet sides. Additional microsection analysis showed that there is no surface diffusion into the sheet; suitable.

As can be seen from the above evaluation, some products are not suitable as release agents in high temperature service. Although ZrO₂ spray and boron nitride spray are able to maintain sheet releasability, contamination of plants or products occurs because the flaking of the ZrO₂ spray layer after high-temperature use requires special cleaning in sintering plants, and boron nitride spray borates the annealed material at the surface. In addition, the use of sprays is only suitable to a limited extent in a production environment with series production.

To the contrary, the use of a layer applied by means of Y₂O₃ suspension allows easy separation of Mo sheets annealed at 1900° C. The layer does not flake off the surface of the annealed material. The layer does not flake off the sheets and there is no diffusion of the layer into the surface of the sheets. Therefore, Y₂O₃ is excellent as a release agent in high temperature applications.

In another series of experiments, 1 mm molybdenum sheets (area 265 mm×265 mm) were coated on both sides with a Y₂O₃ suspension and used for several stacking anneals 1850° C. for 6 h in a hydrogen atmosphere as separator sheets between molybdenum charging sheets (each paired side by side; 2 mm×130 mm×260 mm). For stacking, a Mo— Y₂O₃ separator plate was followed by two charging plates placed side by side, followed by a separator plate, and so on. The charging plate layers were rotated alternately by 90° to form a cross-layer structure. The stacks comprised between 20 and 25 charging plate layers. The separator sheets were still operational after 13 applications.

Due to the Y₂O₃ layer, sintering of the charging sheets does not occur. The stacked plates could also be separated again without problems after annealing. The Y₂O₃ layer adheres stably to the separator plates even after several applications. After heat treatment, the sheets can always be easily separated from each other. Moreover, no negative effects on the base material and the sintering furnace due to contamination were observed. It can be seen that Mo carrier plates with a thin Y₂O₃ layer on both sides are very well suited for high-temperature treatments of charging sheets. In particular, the multiple usability of such Y₂O₃-coated molybdenum separator plates results in a considerable economic and ecological advantage and over tungsten fines.

1-12. (canceled)

13. A component consisting of a refractory metal and having a surface at least partially coated with a layer of yttrium oxide.

14. The component according to claim 13, wherein said refractory metal is a metal selected from the group consisting of titanium, zirconium, hafnium, vanadium, niobium, tantalum, chromium, molybdenum, tungsten, rhenium, and alloys of said metals.

15. The component according to claim 13, wherein said refractory metal consists of at least 70% by weight of molybdenum.

16. The component according to claim 13, comprising a component body formed as a bolt, a nut, a pin, a dowel pin, a washer, a bolt, a sheet, a clamp, a tube, a rod, or a U-shaped rail.

17. The component according to claim 13, being an assembly of welded and/or riveted individual parts.

18. The component according to claim 13, wherein the layer of Y₂O₃ layer has a thickness in a range from 10 μm to 150 μm.

19. The component according to claim 13, wherein the surface of the component is completely coated.

20. The component according to claim 13, wherein the surface of the component is only partially coated.

21. The component according to claim 13, wherein the layer of Y₂O₃ is a Y₂O₃ layer applied to the surface by slurry coating.

22. A component for a high-temperature application, comprising a layer of yttria forming a separating agent for the component for the high-temperature application.

23. A method of manufacturing a coated component, the method comprising the following steps:
providing a component consisting of a refractory metal; and
applying a layer of yttrium oxide to at least a portion of a surface of the component by slurry coating.

24. The method according to claim 23, which comprises providing an ethanol-based Y₂O₃ slurry and coating the component from the slurry.
